(19) United States
(12) Patent Application Publication
(10) Pub. No.: US 2005/0024987 A1
(43) Pub. Date: Feb. 3, 2005

(54) Kneader

(76) Inventors: Alfred Kunz, Witterswil (CH); Daniel Arnaud, Hirsingue (FR)

Correspondence Address: BACHMAN & LAPOINTE, P.C., 900 CHAPEL STREET, SUITE 1201, NEW HAVEN, CT, 06510, US

(21) Appl. No.: 10/493,195

(22) PCT Filed: Oct. 16, 2002
(86) PCT No.: PCT/EP02/11578

(30) Foreign Application Priority Data
Oct. 18, 2001 (DE) 10150900.6

(51) Int. Cl. B01F 7/04

(52) U.S. Cl. 366/97

(57) ABSTRACT

A kneader for carrying out mechanical, chemical and/or thermal processes, comprising at least two shafts, which rotate in a manner that is parallel to the axis and which are situated inside a housing having an inner wall. Kneading bars, which follow one another in a direction of rotation and in an axial direction of the shafts and which extend along the inner wall of the housing and in the direction of the shafts or diagonal thereto, are located on the shafts while being mounted on a supporting element. The paths of the kneading bars on both shafts overlap at least partially and, during rotation, the kneading bars on one shaft engage between the supporting elements on the other shaft. The supporting elements are of different thicknesses and are arranged in succession in a direction of rotation (X) on the shaft while being situated on and/or in a radial plane (E).

### BACKGROUND OF THE INVENTION

The invention relates to a mixing kneader for carrying out mechanical, chemical and/or thermal processes with at least two shafts rotating axially parallel in a housing with an inside wall, kneading bars being located on a carrying element, following one another in succession on the shafts in the direction of rotation and in the axial direction of the shafts, running along the inside wall of the housing and in the direction of the shafts or obliquely thereto, the paths of the kneading bars on the two shafts overlapping at least partly and the kneading bars on one shaft engaging between the carrying elements on the other shaft during rotation.

Such mixing kneaders serve for a wide variety of different purposes. To be mentioned first is evaporation with solvent recovery, which is performed batchwise or continuously and often also under a vacuum. This is used for example for treating distillation residues and, in particular, toluene diisocyanates, but also production residues with toxic or high-boiling solvents from the chemical industry and pharmaceutical production, wash solutions and paint sludges, polymer solutions, elastomer solutions from solvent polymerization, adhesives and sealing compounds.

The apparatuses are also used for carrying out continuous or batchwise contact drying of water-moist and/or solvent-moist products, often likewise under a vacuum. Intended applications are in particular for pigments, dyes, fine chemicals, additives, such as salts, oxides, hydroxides, antioxidants, temperature-sensitive pharmaceutical and vitamin products, active substances, polymers, synthetic rubbers, polymer suspensions, latex, hydrogels, waxes, pesticides and residues from chemical or pharmaceutical production, such as salts, catalysts, slags, waste liquors. These processes also find applications in food production, for example in the production and/or treatment of block milk, sugar substitutes, starch derivatives, alginates, for the treatment of industrial sludges, oil sludges, bio sludges, paper sludges, paint sludges and generally for the treatment of tacky, crust-forming viscous-pasty products, waste products and cellulose derivatives.

In mixing kneaders, degassing and/or devolatilization can take place. This is applied to polymer melts, to spinning solutions for synthetic fibers and to polymer or elastomer granules or powders in the solid state.

In a mixing kneader, a polycondensation reaction can take place, usually continuously and usually in the melt, and is used in particular in the treatment of polyamides, polyesters, polyacetates, polyimides, thermoplastics, elastomers, silicones, urea resins, phenolic resins, detergents and fertilizers.

A polymerization reaction can also take place, likewise usually continuously. This is applied to polyacrylates, hydrogels, polyols, thermoplastic polymers, elastomers, syndiotactic polystyrene and polyacrylamides.

Quite generally, solid/liquid and multi-phase reactions can take place in the mixing kneader. This applies in particular to back-reactions, in the treatment of hydrofluoric acid, stearates, cyanates, polyphosphates, cyanuric acids, cellulose derivatives, cellulose esters, cellulose ethers, polyacetyl resins, sulfanilic acids, Cu-phthalocyanines, starch derivatives, ammonium polyphosphates, sulfonates, pesticides and fertilizers.

Furthermore, solid/gas reactions can take place (for example carboxylation) or liquid/gas reactions can take place. This is applied in the treatment of acetates, azides, Kolbe-Schmitt reactions, for example BON, Na salicylates, parahydroxybenzoates and pharmaceutical products.

Liquid/liquid reactions take place in the case of neutralization reactions and transesterification reactions.

Dissolution and/or degassing takes place in such mixing kneaders in the case of spinning solutions for synthetic fibers, polyamides, polyesters and celluloses.

What is known as flushing takes place in the treatment or production of pigments.

A solid-state post-condensation takes place in the production or treatment of polyester and polyamides, a continuous slurrying, for example in the treatment of fibers, for example cellulose fibers, with solvents, crystallization from the melt or from solutions in the treatment of salts, fine chemicals, polyols, alkoxides, compounding, mixing (continuously and/or batchwise) in the case of polymer mixtures, silicone compounds, sealing compounds, fly ash, coagulation (in particular continuously) in the treatment of polymer suspensions.

In a mixing kneader, multi-functional processes can also be combined, for example heating, drying, melting, crystallizing, mixing, degassing, reacting—all of these continuously or batchwise. Substances which are produced or treated by this means are polymers, elastomers, inorganic products, residues, pharmaceutical products, food products, printing inks.

In mixing kneaders, vacuum sublimation/desublimation can also take place, whereby chemical precursors, for example anthraquinone, metal chlorides, organometallic compounds etc. are purified. Furthermore, pharmaceutical intermediates can be produced.

A continuous carrier-gas desublimation takes place, for example, in the case of organic intermediates, for example anthraquinone and fine chemicals.

A mixing kneader of the type stated above is known for example from EP 0 517 068 B1. In it, two shafts extending axially parallel rotate in a counter-rotating or co-rotating manner in a mixer housing. In this case, mixing bars mounted on disk elements act with one another. Apart from the function of mixing, the mixing bars have the task of cleaning as well as possible surfaces of the mixer housing, of the shafts and of the disk elements that are in contact with product and of thereby avoiding unmixed zones. In particular in the case of highly compacting, hardening and crust-forming products, the ability of the mixing bars to reach the edges leads to high local mechanical loading of the mixing bars and of the shafts. These force peaks occur in particular when the mixing bars engage in those zones where the product finds it difficult to escape. Such zones are present, for example, where the disk elements are mounted on the shaft.

Furthermore, DE 199 40 521 A1 discloses a mixing kneader of the aforementioned type in which the carrying elements form a recess in the region of the kneading bars in order that the kneading bar has the greatest possible axial extent. Such a mixing kneader has outstanding self-cleaning of all the surfaces of the housing and of the shafts that come into contact with the product, but has the characteristic that the carrying elements of the kneading bars require recesses on account of the paths of the kneading bars, leading to complicated forms of the carrying elements. One result of this is a complex production process and another result is local stress peaks at the shaft and the carrying elements under mechanical loading. These stress peaks, which occur primarily at the sharp-edged recesses and changes in thickness, in particular in the region where the carrying elements are welded onto the core of the shaft, are causes of cracks in the shaft and the carrying elements as a result of material fatigue.

It is a principle object of the present invention optimizing the aforementioned mixing kneader so that the stress peaks which act on the shaft and the carrying elements are reduced.

### SUMMARY OF THE INVENTION

The foregoing object is achieved by providing carrying elements of different thicknesses which are arranged on the shaft, following in succession in the direction of rotation on and/or at a radial plane.

Consequently, a carrying element no longer has a differing thickness, seen in the direction of rotation, but retains its thickness. This simple form allows dangerous stress peaks to be significantly reduced on account of the avoidance of sudden changes in material thickness and sharp-edged transitions. Consequently, the torques of the shaft can be significantly increased, without the shaft undergoing any damage.

Furthermore, the thick carrying elements, which by their very nature have significantly better mechanical stability, protect the thin carrying elements following them in the direction of rotation. The thick carrying elements clear the way for the thin carrying elements.

The thick carrying elements preferably lie with their center line on the radial plane. On the other hand, the thinner carrying elements lie with one of their side faces against the radial plane, to be precise preferably a thinner carrying element which precedes the thicker carrying element lies with one side face against it, whereas the other thinner carrying element, which follows the thicker carrying element, lies with the other side face against it. Consequently, the thinner carrying elements are not only arranged offset with respect to the thicker carrying elements, but they are also offset with respect to one another.

In a preferred exemplary embodiment, the thicker carrying element is at least twice as thick as a thin carrying element. This means in turn that, with the offset described above, the outer faces of the thinner carrying elements in each case lie in the plane of the outer faces of the thicker carrying elements. Also as a result of this, the loading of the thinner carrying elements is once again reduced.

The carrying elements are preferably formed in a segmental manner, so that clearances are formed between them, through which the product can be moved in the axial direction of the mixing kneader.

The carrying elements are preferably designed such that they can be heated and/or cooled, being supplied with a corresponding heating or cooling medium.

### BRIEF DESCRIPTION OF THE DRAWINGS

Further advantages, features and details of the invention emerge from the description which follows of preferred exemplary embodiments and on the basis of the drawing, in which:

FIG. 1 shows a plan view of a mixing kneader according to the invention with a partly cut-open housing;

FIG. 2 shows a cross section through a shaft of a mixing kneader with carrying and kneading elements;

FIG. 3 shows a section through the shaft according to FIG. 2 along line III-III;

FIG. 4 shows a developed protection of the shaft of the mixing kneader according to FIG. 2 with a series of carrying and kneading elements on the shaft.

### DETAILED DESCRIPTION

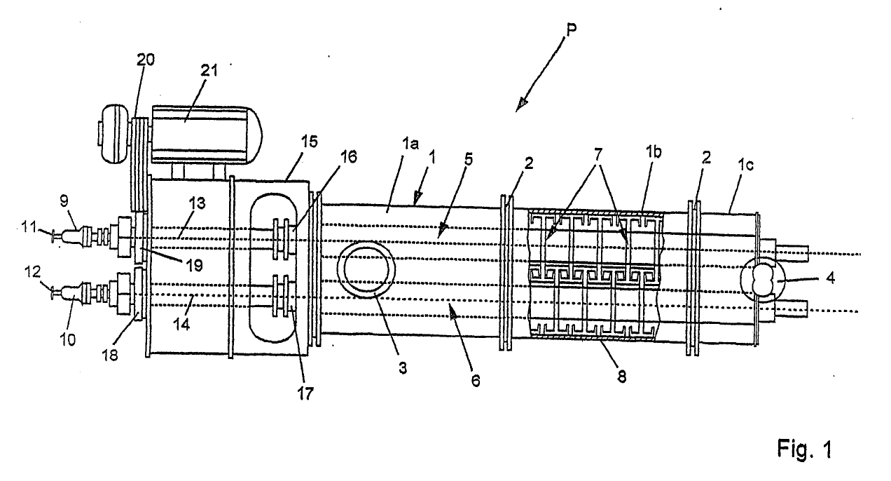

A mixing kneader P has, according to FIG. 1, a housing, which may comprise a number of housing sections 1a, 1b and 1c. The housing sections are coupled to one another by corresponding flange connections 2. Provided in the housing section 1a is a feed stub 3 for a product that is to be treated in the mixing kneader and provided in the housing section 1c is an outlet stub 4 for the product that has been treated.

The product is transported from the feed stub 3 to the outlet stub 4 by means of two shafts 5 and 6 and also kneading and transporting elements 7 arranged on them. During the transport, a mixing and kneading of the product takes place and preferably also a thermal treatment. For this purpose, the shafts 5 and 6, and possibly also the kneading and transporting elements 7 are heated, and so too is the housing wall 8 (not shown in any more detail). For introducing a heating medium into the shafts 5 and 6 and from there possibly into the interior of the kneading and transporting elements 7, connections 9 and 10 are arranged around corresponding inlet and outlet stubs 11 and 12 for the heating medium passed through the shafts 5 and 6. Corresponding conduction of the heating medium in outer cylindrical surfaces of the shafts 5 and 6 and corresponding return through the outlet stub 12 are state of the art and therefore not described any further.

Between the connections 9 and 10, shaft journals 13 and 14 that are connected to the shafts 5 and 6 pass through a cage 15, with a stuffing box 16 and 17 respectively provided against the housing 1 to seal off the shafts 5 and 6. The shaft journals 13 and 14 are coupled to one another outside the cage by means of a corresponding synchronizing gear mechanism with the gear wheels 18 and 19, the synchronizing gear mechanism being connected to a drive 21 via a belt drive 20. By means of this drive 21 and the belt drive 20, the gear wheels 18 and 19 are set in rotational movement, which are transmitted to the shafts 5 and 6. Transmission of this rotational movement to the shafts 5 and 6 takes place in the same direction with the same rotational speed. Corresponding synchronizing gear mechanisms are state of the art and are not to be described in any more detail here.

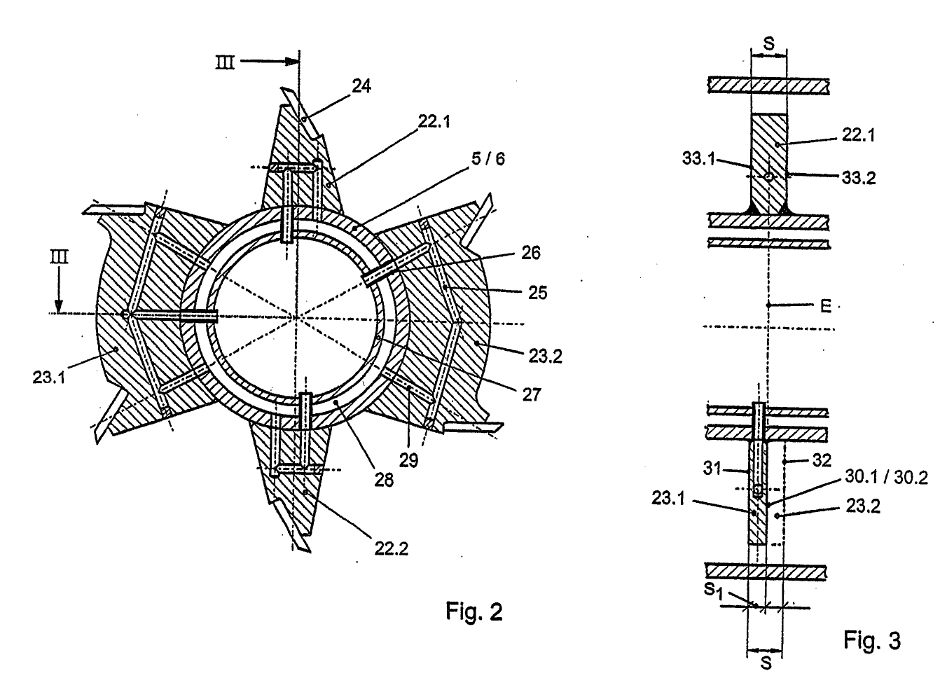

According to FIG. 2, seated on the shaft 5/6 are carrying elements 22.1 and 22.2 and also 23.1 and 23.2, to the periphery of which at least one kneading bar 24 is respectively fastened.

Each carrying element is preferably to be capable of being cooled or heated. For this purpose, provided in the respective carrying element are bores 25, which are in connection with the interior of an inner tube 27 by means of pipe connections 26.

The supply of heating/cooling medium takes place through an annular gap 28 between the inner tube 27 and the shaft 5/6, and also through radial bores 29 to the bores 25. The return then takes place via the pipe connection 26 back into the interior of the inner tube 27.

According to the invention, the carrying elements are formed with different thicknesses. According to FIG. 3, the thicker carrying elements 22.1/22.2 have a thickness s, which is at least twice as thick as the thickness s, of a thin carrying element 23.1/23.2. The carrying element 23.2 is represented by dash-dotted lines.

Likewise represented by dash-dotted lines is a radial plane E, which also forms a center line for the thicker carrying elements 22.1 and 22.2, respectively. On the other hand, the thinner carrying elements 23.1 and 23.2 lie with one of their side faces 30.1/30.2 respectively against this radial plane E. Since the thinner carrying elements 23.1 and 23.2 are formed only half as thick as the thicker carrying elements 22.1 and 22.2, the respectively outer side faces 31 and 32 lie approximately in the plane of the outer side faces 33.1 and 33.2 of the thicker carrying elements 22.1 and 22.2, respectively.

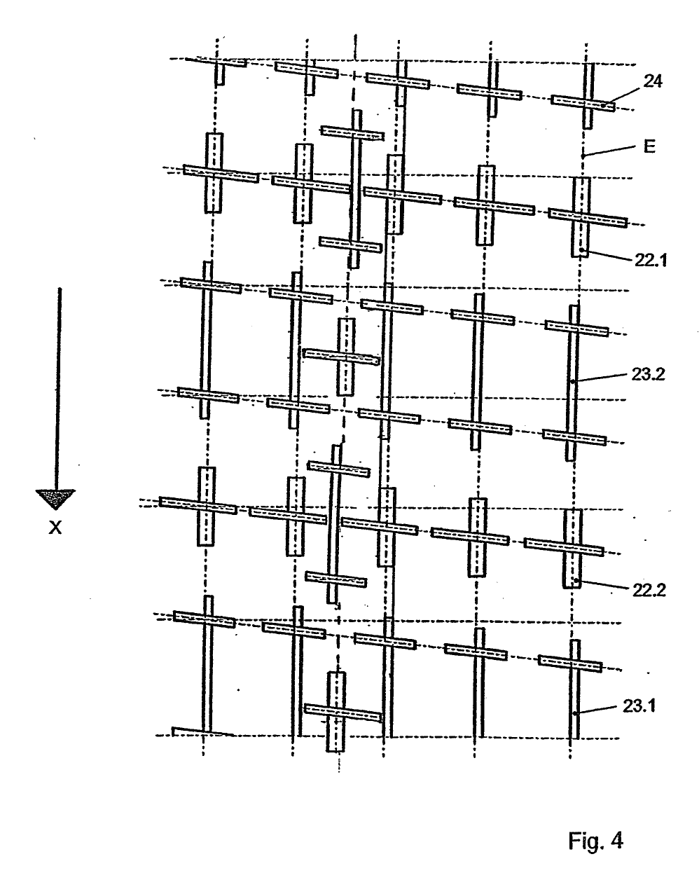

In FIG. 4, the arrangement of the kneading bars 24 and the carrying elements 22.1, 22.2 and 23.1, 23.2 is represented as a developed projection by way of example. It is evident from this that, when there is rotation of the shaft in the direction of rotation x, the thicker carrying elements in the radial plane E protect as it were the thinner carrying elements 23.1 and 23.2, in that they clear the way for them. Furthermore, however, it is also evident that the kneading bars 24 are arranged from rings of kneading and transporting elements adjacent in the axial direction in such a way that, although they can be passed through by the carrying elements of the other shaft, they are at the same time respectively arranged offset in the axial direction in such a way that there is no trace on the inside wall of the housing of the mixing kneader that is not cleaned off by kneading bars 24.

Also shown in FIG. 4 is a developed projection of carrying elements with kneading bars of the other shaft as they engage in the carrying elements or kneading bars of the one shaft. In order to allow the thicker carrying elements through, it goes without saying that the distance between two kneading bars is chosen to be larger than in the case in which thinner carrying elements have to be allowed through. Furthermore, here, too, the axial offset of a thinner carrying element with respect to a thicker carrying element and a following thinner carrying element can be seen.

1. A mixing kneader comprises:
at least two substantially parallel shafts (5, 6) mounted for rotation in a housing (1); and
a plurality of carrying elements (22.1, 22.2, 23.1, 23.2) mounted in succession, axially on each of the shafts (5, 6), each of the carrying elements having a periphery proximate to an inside wall of the housing, wherein a kneading bar is located on each of the peripheries wherein the kneading bars on the carrying elements on one of the shafts at least partially overlap the kneading bars on the carrying elements on the other of the shafts, wherein the carrying elements on each of the shafts have different thicknesses and lie on a radial plane (E).

2. The mixing kneader as claimed in claim 1, wherein the thicker carrying elements (22.1, 22.2) have a center line on the radial plane (E).

3. The mixing kneader as claimed in claim 2, wherein the thinner carrying elements (23.1, 23.2) have side faces (30.1, 30.2) lie against the radial plane (E).

4. The mixing kneader as claimed in claim 3, wherein, in the direction of rotation (X), a thicker carrying element (22.1 or 22.2) is preceded by a thinner carrying element (23.1 or 23.2), wherein one end face (30.1 or 30.2) of which lies against the radial plane (E) from the one axial direction, whereas it is followed by a thinner carrying element (23.2 or 23.1), which rests with a side face (30.2 or 30.1) against the radial plane (E) from the other direction.

5. The mixing kneader as claimed in claim 1, wherein the thicker carrying element (22.1, 22.2) is at least twice as thick as the thinner carrying element (23.1, 23.2).

6. The mixing kneader as claimed in claim 5, wherein the thinner carrying element (23.1, 23.2) is formed longer in a direction of rotation (X) than the thicker carrying element (22.1, 22.2).

7. The mixing kneader as claimed in claim 1, wherein the carrying elements (22.1, 22.2, 23.1, 23.2) are formed in a segmental manner.

8. The mixing kneader as claimed in claim 1, wherein the carrying elements (22.1, 22.2, 23.1, 23.2) are heated and/or cooled.
